(19) United States
(12) Patent Application Publication
(10) Pub. No.: US 2013/0158899 A1
(43) Pub. Date: Jun. 20, 2013

(54) METHOD OF MEASURING THE VISCOCITY OF A FLUID AND VISCOSIMETER

(71) Applicants: Nicolas Gascoin, St Germain du Puy (FR); Guillaume Fau, Bourges (FR); Philippe Gillard, Bourges (FR); Denis Blanc, Saint Doulchard (FR)

(72) Inventors: Nicolas Gascoin, St Germain du Puy (FR); Guillaume Fau, Bourges (FR); Philippe Gillard, Bourges (FR); Denis Blanc, Saint Doulchard (FR)

(73) Assignee: UNIVERSITE D'ORLEANS, Orleans (FR)

(21) Appl. No.: 13/819,144

(22) PCT Filed: May 3, 2012
(86) PCT No.: PCT/FR2012/050988

§ 371 Date: Feb. 26, 2013

(30) Foreign Application Priority Data
May 4, 2011 (FR) 11 53829

(51) Int. Cl. G01N 11/08; G06F 17/00

(52) U.S. Cl. CPC G01N 11/08; G06F 17/00
USPC 702/50; 73/54.13

(57) ABSTRACT

A method for measuring the viscosity of any liquid gaseous or supercritical, optionally multiphase fluid, under extended conditions of pressure, temperature and chemical composition, the method is based on the application of a flow law of the fluid through a permeable medium, the permeability of which is known. A viscosimeter for carrying out this measurement method is also described.

### TECHNICAL FIELD OF THE INVENTION

The present invention relates to the field of rheology. More precisely, the present invention provides a method for measuring the viscosity of a liquid, gaseous or supercritical, optionally multiphase fluid under extended conditions of pressure and temperature. The present invention furthermore relates to a viscosimeter for carrying out the measurement method.

### PRIOR ART

Viscosity characterizes the ability of a fluid to flow. Characterization of the properties of fluids is useful in science, but also in numerous industrial sectors, for example the gas and oil sectors, petrochemistry, the automotive industry, the aeronautical industry, the maritime sector, the chemical industry and the food industry, and even in the medical sector. Viscosity measurement can, for example, make it possible to control the progress of a reaction or supervise an industrial process.

The viscosity generally measured by apparatuses available on the market is the dynamic viscosity, denoted by μ (the Greek letter mu). The official unit of μ is the pascal-second (Pa·s).

Knowledge of the kinematic viscosity, denoted by ν (the Greek letter nu), can also be useful in certain contexts. The official unit of ν is the square meter per second (m²/s).

The dynamic and kinematic viscosities are associated with one another by the following relation:

$$v = \frac{μ}{ρ}$$

in which ρ (the Greek letter rho) is the density of the fluid, in kilograms per cubic meter (kg/m³).

Conventionally, the dynamic viscosity can be measured by studying capillary flows with a pressure measurement. There are various measurement apparatuses on the market, for example capillary viscosimeters, falling-sphere viscosimeters, coaxial-cylinder (Couette) viscosimeters, cone and plate viscosimeters and resonance viscosimeters. There is also an optical method.

These methods are dedicated to a specific type of fluid (liquid or gas) under very restricted conditions of pressure and temperature. To the knowledge of the Inventors, the highest temperatures with which viscosity measurements have been carried out are of the order of 250° C. and 300° C. It would nevertheless be advantageous to be able to overcome these limitations in terms of pressure and temperature.

Furthermore, most known apparatuses for measuring viscosity can only be used on fluids at rest, or static fluids, that is to say ones without flow. This only allows measurements in a laboratory on fixed systems. However, numerous industrial processes require measurements carried out directly online and continuously. This is because it would be desirable to be able to measure the viscosity of a fluid having a nonzero flow rate imposed by the system in which the fluid is contained, that is to say the flow rate of the fluid is not imposed by the device for measuring the viscosity per se.

In order to meet this requirement inter alia, Paul Kalotay has described in a scientific publication (ISA Transactions 38 (1999) 303-310) a device for online measurement of the density and the dynamic and kinematic viscosities of fluids by the use of a Coriolis-effect mass flow meter. The device consists of a Coriolis-effect mass flow meter fixed to a tube through which the analyzed fluid passes. The pressure drop created by the flow meter on the line is measured by a differential pressure sensor. The viscosity is calculated on the basis of the Hagen-Poiseuille equation. However, this device does not make it possible to measure the viscosity at high pressure and/or high temperature, because the Coriolis-effect flow meter would not withstand being subjected to such temperature and/or pressure conditions.

The patent application EP 0 840 104 describes a viscosity measurement apparatus designed to operate over a wide pressure range. However, this device cannot be used online. This is because the fluid is set in motion with the aid of two hydraulic cylinders in this method. Furthermore, the device does not comprise a flow meter because the fluid flow rate is predetermined with the aid of movement of pistons.

The American patent U.S. Pat. No. 4,884,577 relates to a method and to a device which is intended very specifically for measuring the viscosity of blood. The description of this document clearly and unambiguously reveals that the device described does not comprise a flow meter. Moreover, this device does not make it possible to measure the viscosity of a fluid which is already in flow. Furthermore, the method described is not intended for use at high pressure or at high temperature, and it is not applicable for fluids which are affected little by gravity, such as gases or supercritical fluids.

The scientific article by Jeroen Billen et al. (“Influence of pressure and temperature on the physico-chemical properties of mobile phase mixtures commonly used in high-performance liquid chromatography”, Journal of Chromatography A, 1210 (2008) 30-44) describes research work on physico-chemical parameters such as the density, the isothermal compressibility and the viscosity of water/methanol and water/acetonitrile solvent mixtures in particularly high pressure and temperature ranges. These data are intended to be used as a reference for HPLC (high-performance liquid chromatography) measurements. The viscosity measurement device used employs a stainless steel capillary. However, such capillary systems generate a very high pressure drop, which is not compatible with use in an industrial process. Furthermore, as the pressure of the fluid varies along the capillary, the uncertainty of the viscosity measurement with the aid of this device is large and necessitates the use of a theoretical pressure model.

Lastly, the American patent application US 2009/0084164 describes a method and a device for monitoring the clogging of a filter within a system employing fluid flows. This device does not comprise a device for measuring the flow rate and cannot be used online. This is because the system needs to be shut down in order to carry out a cycle of monitoring the clogging of the filter. Furthermore, the use of a filter presents several drawbacks. On the one hand, the filter must have a shape and a particular dimension for carrying out the filtration of the flow optimally. Depending on the thickness of the fluid, a tubular shape causes a difference between the dimension of the interior surface of the filter and the dimension of the exterior surface of the filter. The cross section of the passage is therefore poorly defined, which generates uncertainties in the viscosity calculation. Furthermore, the filter can be deformed under the effect of the pressure difference.

No device is available for the direct measurement of viscosity at high levels of temperature and pressure on any type of fluid. There are certain research works, but these use conventional measurement methods which are not extended or extrapolated by calculation.

Furthermore, when the fluid is a multiphase fluid, typically when it is a liquid fluid containing gas bubbles, the current apparatuses may become blocked or no longer display any value.

In the prior art, there are furthermore devices which, knowing the viscosity of a fluid, make it possible to measure the permeability of a sample through which said fluid passes.

The scientific article by Takahiro Tomita et al. (“Effect of viscosity on preparation of foamed silica ceramics by rapid gelation foaming method”, Journal of Porous materials 12: 123-129, 2005) describes research in a field very different from the present invention, namely the preparation of silica ceramic foams by a sol-gel method. A test device for testing the permeability of the ceramics obtained is used. It consists of a ring on which the sample to be tested is mounted, this ring being arranged between two conduits and the assembly being held with the aid of a clamping collar. The pressure is measured directly in the conduits before and after the sample to be tested, and is therefore vitiated by the regular pressure drop of the tubes. Furthermore, this device is not capable of use at high temperature because of the presence of acrylic resin and silicone resin where the sample is fixed.

There is therefore still a need for new methods and new devices for measuring the viscosity of any fluid liquid, gaseous or supercritical, optionally multiphase fluid under extended conditions of pressure and temperature. These methods and devices are intended to be used on a fluid in flow, and should advantageously make it possible to carry out measurements continuously. Furthermore methods and devices are sought which advantageously permit viscosity measurement with a minimal uncertainty and a high reproducibility.

### DESCRIPTION OF THE INVENTION

In order to satisfy this requirement, the Inventors have developed a method for measuring the viscosity of a fluid which is based on the application of a flow law of the fluid through a permeable medium, the permeability of which is known.

The present invention relates to a method for measuring the viscosity of a fluid, comprising the steps consisting in:
passing the fluid through a permeable material;
measuring the flow rate of the fluid by means of a flow meter;
measuring the pressure difference of the fluid between the pressure upstream of the permeable material and the pressure downstream of the permeable material;
applying a flow law of the fluids through a permeable material in order to determine the viscosity of the fluid.

A flow law of the fluids through a permeable medium is selected in particular from Darcy's law and Brinkman's law.

According to a particular embodiment, this method makes it possible to measure the kinematic viscosity of the fluid.

The present invention also relates to a viscosimeter comprising:
a cell comprising two chambers separated by a permeable material, the first chamber comprising an inlet opening and the second chamber comprising an outlet opening for a fluid;
a means for measuring the pressure difference between the first and second chambers;
a flow meter for measuring the flow rate of the fluid.

### BRIEF DESCRIPTION OF THE DRAWINGS

Other characteristics and advantages of the invention will become apparent on studying the following detailed description and the appended drawings, in which:

FIG. 1 is an exploded view of an embodiment of the cell of the viscosimeter according to the present invention;

FIG. 2 is a diagram in section of the cell represented in FIG. 1 in the assembled state;

FIG. 3 is a diagram in section of a part of the cell according to one embodiment of the present invention.

### DETAILED DESCRIPTION

In the context of the present invention, a permeable material is intended to mean a material having a Darcy permeability, denoted by K_{D}, of between 10⁻²⁰ and 10⁻⁸ m², preferably between 10⁻¹⁸ and 10⁻¹¹ m². This is an intrinsic characteristic of the material, which does not depend on the nature, or the temperature or the pressure, of the fluid which passes through it. This constant K_{D} can be measured experimentally on a test bench with a fluid, for example nitrogen, the properties of which are well known. The measurement may, for example, be carried out according to the standard ISO 4022 relating to the determination of permeability to fluids.

Advantageously, the permeable material may be an undeformable solid, that is to say a material which does not deform significantly when it is subjected to a pressure difference such as that which may be imposed when carrying out the method according to the invention. Furthermore, the permeable material may advantageously comprise two parallel plane faces having the same surface area. This surface may have any shape, although it is preferably round. A surface may have a cross section of between 12 and 8.10⁷ mm². Thus, the permeable material according to the invention may advantageously be a round pellet having a thickness of between 0.1 and 50 mm, and a diameter of between 4 and 1000 mm.

Advantageously, the fluid may pass through the permeable material perpendicularly to the surface of the material.

The flow rate of the fluid may be measured using any flow meter known to the person skilled in the art and adapted to the operating conditions of the method. A flow meter is an apparatus dedicated to measuring the flow rate of a fluid flowing in the air or in a conduit. Distinction is generally made between mass flow meters, for measuring the mass flow rate of fluid, and volume flow meters for measuring the volume flow rate of fluid.

According to a particular embodiment, it is the mass flow rate of the fluid which is measured, by means of a mass flow meter. Measurement of the mass flow rate has the advantage that it can be carried out at any position of the line in which the fluid to be analyzed circulates, if there is no pressure drop or addition of mass. The operating conditions (in terms of pressure and temperature) of the mass flow rate measurement need not be the same as the operating conditions at the permeable material. In particular, a mass flow meter may be installed upstream or downstream of the permeable material, in a zone having ideal operating conditions for the operation of the mass flow meter, for example in a stable support and under conditions of ambient temperature and atmospheric pressure.

The flow rate of the fluid may in particular be measured with a Coriolis-effect flow meter. This type of flow meter, which is known to the person skilled in the art, is described for example in the publication by Kalotay (cited above). A Coriolis-effect flow meter makes it possible to experimentally measure the density and the mass flow rate of a fluid.

Other mass flow meters may be used.

Typically, the method according to the present invention may be carried out on fluids whose mass flow rate is between 10⁻⁹ kg/s and 4.10² kg/s. The person skilled in the art will know how to select the flow meter suitable for the conditions of the measurement which he wishes to carry out.

According to another embodiment, the measured flow rate of the fluid is the volume flow rate or the velocity of the fluid. Since the surface area of the cross section of the permeable material, through which the fluid passes, is a parameter accessible to the operator, the volume flow rate and the velocity of the fluid can be obtained from one another.

According to this embodiment, the person skilled in the art will know how to select the volume flow meter suitable for the conditions and for the precision of the measurement which he wishes to carry out. By way of example, the volume flow meter is selected from the group consisting of vortex, ultrasonic, hot-wire thermal, ball, float and wheel flow meters.

The passage of the fluid through the permeable material generates a pressure drop, which can be measured by the pressure difference between the pressure of the fluid upstream of the permeable material and the pressure of the fluid downstream of the permeable material.

The pressure difference may be measured with two pressure sensors, by subtracting the two results, or with a single differential pressure sensor. The use of a single differential pressure sensor in the method according to the present invention has the advantage of avoiding a discrepancy over time between the measurement of the pressure upstream of the measurement of the pressure downstream and the permeable material. Furthermore, the use of a single differential pressure sensor advantageously makes it possible to achieve a better precision of the measurement.

The pressure upstream and downstream of the permeable material may advantageously be measured inside chambers in which the dynamic pressure of the flow is substantially zero. This is because if the pressure measurement is carried out outside the chambers, for example directly in the conduit of the fluid, a regular pressure drop term is to be taken into account in the value of the pressure measured, which increases the uncertainty of the calculated viscosity.

By way of example, the pressure sensor is selected from the group consisting of piezoelectric sensors, piezoresistive sensors, manometers and water columns.

The person skilled in the art will know how to select the sensor suitable for the conditions and for the precision of the measurement which he wishes to carry out.

The pressure difference typically measurable in the method according to the present invention is between 0.1 mbar and 150 bar.

The value of the viscosity of the fluid is obtained according to the method of the present invention by applying a flow law of the fluids through a permeable medium.

In the case in which the fluid flows in a laminar fashion through the permeable material, a flow law of the fluids through a permeable medium may in particular be Darcy's law.

Darcy's law is known to the person skilled in the art in the following form:

$$\frac{Δ P}{L} = \frac{μ \cdot V}{{K}_{D}}$$

in which:

ΔP denotes the pressure difference of the fluid between the pressure upstream of the permeable material and the pressure downstream of the permeable material (in Pa),

L denotes the thickness of the permeable material passed through (in m),

μ denotes the dynamic viscosity of the fluid (in Pa·s),

V denotes the average velocity of the fluid in the permeable material (in m/s), et

K_{D} denotes the Darcy permeability of the permeable material (in m²).

The value of K_{D} is a constant of the permeable material. Thus, knowing the nature and the dimensions of the permeable material used, in particular the thickness L (in m) and the cross section S (in m²) of the permeable material passed through, measuring the flow rate of the fluid and the pressure difference makes it possible to obtain the value of the viscosity of the fluid directly.

Knowing the pressure difference ΔP, if the velocity of the fluid V (in m/s) or its volume flow rate Dᵥ (in m³/s) is measured, the dynamic viscosity μ (in Pa·s) can be obtained directly:

$$μ = \frac{{K}_{D}}{L} \times \frac{Δ P}{V} = \frac{{K}_{D} \cdot S}{L} \times \frac{Δ P}{{D}_{v}} .$$

Knowing the pressure difference ΔP, if the mass flow rate of the fluid Dₘ (in kg/s) is measured, the kinematic viscosity ν (in m²/s) can be obtained directly:

$$v = \frac{{K}_{D} \cdot S}{L} \times \frac{Δ P}{{D}_{m}} .$$

Furthermore, if the density of the fluid ρ (in kg/m³) is known or obtained by another measurement, the kinematic viscosity and dynamic viscosity can be obtained from one another.

In the case in which the fluid flows not in a laminar fashion but in a turbulent fashion through the permeable material, a flow law of the fluids through a permeable medium may in particular be Brinkman's law:

$$μ = \frac{{K}_{D} \cdot S}{L} \times \frac{Δ P}{{D}_{v}} - \frac{{K}_{D}}{{K}_{F} \cdot S} \times {ρ}_{av} \cdot {D}_{V}$$

$$v - \frac{{K}_{D} \cdot S}{L} \times \frac{Δ P}{{D}_{m}} - \frac{{K}_{D}}{{K}_{F} \cdot S} \times \frac{{D}_{m}}{{ρ}_{av}} .$$

in which μ, ν, K_{D}, S, L, ΔP, Dᵥ and Dₘ are as defined above, in which ρₐᵥ denotes the average density of the fluid upstream and downstream of the permeable material, that is to say (ρ of the fluid upstream of the permeable material+ρ of the fluid downstream of the permeable material)/2, and in which K_{F} denotes the Forchheimer permeability. This is an intrinsic characteristic of the material, which does not depend on the nature, or the temperature or the pressure, of the fluid which passes through it. This constant K_{F} can be measured experimentally, like the constant K_{D}. According to the present invention, the permeable material has a Forchheimer permeability K_{F} of preferably between 10⁻¹⁷ and 10⁻⁴ m.

In this context, Dₘ, Dᵥ and ρₐᵥ are associated with one another by the following relation:

$${ρ}_{av} = \frac{{D}_{m}}{{D}_{V}} .$$

The laminar or turbulent character of the fluid may be determined by calculating the Reynolds number Re (no unit). In the case of flow through a permeable material, the Reynolds number is calculated in the following way:

$$Re = \frac{V \cdot R}{v}$$

where V denotes the velocity of the fluid (in m/s), ν denotes the kinematic viscosity (in m²/s) and R denotes the average diameter of the pores of the permeable material. The average diameter of the pores of the permeable material is known by virtue of the supplier's data, or it may be measured experimentally, for example by nitrogen porosimetry or by scanning electron microscope imaging, according to the methods known to the person skilled in the art.

If Re is less than 1, the flow is considered to be laminar. If Re is greater than 1, the flow is considered to be turbulent.

The person skilled in the art may in particular select a permeable material with a suitable porosity according to the nature and the flow rate of the fluid whose viscosity he wishes to measure, so that the flow is laminar.

Furthermore, the person skilled in the art may also select a permeable material with a thickness and a porosity which is suitable according to the potential variations of the flow rate of the fluid whose viscosity he wishes to measure, so that the flow is in steady-state regime during the passage through the permeable material.

According to a particular embodiment, the present invention relates to a method for measuring the kinematic viscosity of a fluid comprising the steps consisting in:
passing the fluid in a laminar fashion through a permeable material having a Darcy permeability K_{D}, a thickness L and a cross section S which are known;
measuring the mass flow rate Dₘ of the fluid by means of a mass flow meter;
measuring the pressure difference AP of the fluid between the pressure upstream of the permeable material and the pressure downstream of the permeable material;
applying Darcy's law:

$$v = \frac{{K}_{D} \cdot S}{L} \times \frac{Δ P}{{D}_{m}}$$

in order to determine the kinematic viscosity v of the fluid.

According to another particular embodiment, the present invention relates to a method for measuring the kinematic viscosity of a fluid comprising the steps consisting in:
passing the fluid of average density ρₐᵥ in a turbulent fashion through a permeable material having a Darcy permeability K_{D}, a Forchheimer permeability K_{F}, a thickness L and a cross section S which are known;
measuring the mass flow rate Dₘ of the fluid by means of a mass flow meter;
measuring the pressure difference ΔP of the fluid between the pressure upstream of the permeable material and the pressure downstream of the permeable material;
applying Brinkman's law in the form:

$$v = \frac{{K}_{D} \cdot S}{L} \times \frac{Δ P}{{D}_{m}} - \frac{{K}_{D}}{{K}_{F} \cdot S} \times \frac{{D}_{m}}{{ρ}_{av}}$$

in order to determine the kinematic viscosity v of the fluid.

According to another particular embodiment, the present invention relates to a method for measuring the kinematic viscosity of a fluid comprising the steps consisting in:
passing the fluid in a turbulent fashion through a permeable material having a Darcy permeability K_{D}, a Forchheimer permeability K_{F}, a thickness L and a cross section S which are known;
measuring the mass flow rate Dₘ of the fluid by means of a mass flow meter and the volume flow rate Dᵥ of the fluid by means of a volume flow meter;
measuring the pressure difference ΔP of the fluid between the pressure upstream of the permeable material and the pressure downstream of the permeable material;
applying Brinkman's law in the form:

$$v = \frac{{K}_{D} \cdot S}{L} \times \frac{Δ P}{{D}_{m}} - \frac{{K}_{D}}{{K}_{F} \cdot S} \times {D}_{V}$$

in order to determine the kinematic viscosity v of the fluid.

One of the advantages of the method of the present invention is that it can be carried out on a fluid in a very wide range of pressure and temperature.

The pressure of the fluid upstream of the permeable material is preferably between 10⁻⁷ bar (0.01 Pa) and 1000 bar (10⁸ Pa), more preferably between 1 bar (10⁵ Pa) and 800 bar (8×10⁷ Pa), even more preferably between 10 bar (10⁶ Pa) and 500 bar (5×10⁷ Pa), or even between 20 bar (2×10⁶ Pa) and 250 bar (2.5×10⁷ Pa).

The temperature of the fluid is preferably between −40° C. and 1000° C., more preferably between 10° C. and 900° C., and even more preferably between 50° C. and 800° C.

In particular, the method according to the invention makes it possible to measure the viscosity of fluids having both a pressure of between 60 bar (6×10⁶ Pa) and 120 bar (1.2×10⁷ Pa) and a temperature of between 500° C. and 900° C.

The fluid may be in the liquid phase, in the gaseous phase or in the supercritical phase.

The fluid may be a multiphase fluid. According to one embodiment, it may be a liquid fluid containing gas bubbles. The method according to the present invention advantageously makes it possible to measure the apparent viscosity of such a fluid.

The density of the fluid to be tested is preferably between 10⁻⁵ kg/m³ and 2.10³ kg/m³.

Very advantageously, the method according to the present invention therefore makes it possible to measure the dynamic or kinematic viscosity of fluids over a wide range of operating conditions. In these operating ranges:
the measurable dynamic viscosity of the fluid is preferably between 10⁻¹⁰ Pa·s and 10⁶ Pa·s.
the measurable kinematic viscosity of the fluid is preferably between 10⁻¹² m²/s and 10⁶ m²/s.

In order to achieve a correct measurement of these characteristics of the fluid, the permeable medium must be selected judiciously according to the fluid. Knowing the operating conditions in which the fluid is to be tested and the nature of the fluid, a person skilled in the art is capable of judiciously selecting the permeable material to be used in order to carry out the measurement.

Table I below gives examples of permeable material which may be used, and of accessible dynamic and kinetic viscosity ranges:

TABLE I

| | Density of | Dynamic | Kinematic |
|---|---|---|---|
| | the fluid | viscosity | viscosity |
| Permeable material | (in kg/m³) | (in Pa · s) | (in m²/s) |
| Round pellet with | from 0.001 | from 10⁻¹⁰ | from 10⁻¹² |
| thickness 3 mm of | to 2000 | to 10⁻⁶ | to 10⁻³ |
| (316L steel) | | | |
| Federal Mogul, Poral | | | |
| Class 3 | | | |
| Open porosity = 9% | | | |
| K_{D} = 2.10⁻¹³ m² | | | |
| K_{F} = 5 · 10⁻⁷ m | | | |
| Round pellet with | from 0.001 | from 10⁻⁸ | from 10⁻¹⁰ |
| thickness 3 mm of | to 2000 | to 10⁻⁴ | to 10⁻¹ |
| (316L steel) | | | |
| Federal Mogul, Poral | | | |
| Class 40 | | | |
| Open porosity = 45% | | | |
| K_{D} = 1.5 · 10⁻¹¹ m² | | | |
| K_{F} = 2 · 10⁻⁶ m | | | |
| Round pellet with | from 0.001 | from 10⁻⁹ | from 10⁻¹² |
| thickness 2 mm of | to 2000 | to 10⁻² | to 10⁺² |
| (bronze) | | | |
| Federal Mogul, Poral | | | |
| Class 30 | | | |
| Open porosity = 34% | | | |
| K_{D} = 8.8 · 10⁻¹² m² | | | |
| K_{F} = 3 · 10⁻⁶ m | | | |
| Round pellet with | from 0.001 | from 10⁻¹¹ | from 10⁻¹² |
| thickness 2 mm of | to 2000 | to 10⁻⁴ | to 10⁻¹ |
| (C/SiC composite | | | |
| materials) | | | |
| Open porosity < 1% | | | |
| K_{D} = 5 · 10⁻¹⁶ m² | | | |
| K_{F} = 3 · 10⁻¹⁰ m | | | |
| Round pellet with | from 0.001 | from 10⁻⁵ | from 10⁻⁷ |
| thickness 2 mm of | to 2000 | to 10⁺³ | to 10⁺⁶ |
| (bronze) | | | |
| Open porosity > 45% | | | |
| K_{D} = 10⁻⁸ m² | | | |
| K_{F} = 10⁻⁴ m | | | |

Furthermore, the permeable medium may be selected according to the pressure drop allowed by the system in which the fluid flows.

The method to which the present invention relates may advantageously be a method for measuring the viscosity of a fluid online. An “online measurement method” in the present application is intended to mean a measurement method carried out on a fluid having a nonzero flow rate imposed by the system in which the fluid is contained, as opposed to a measurement method which requires isolation of the fluid on which the measurement is carried out. In methods for measuring the viscosity of the fluid which are not online measurements, the fluid is typically set in motion with a flow rate which is imposed by the device for measuring the viscosity per se. The measurement method according to the invention can advantageously be carried out on a fluid whose flow is imposed by a system external to the device for measuring the viscosity. The measurement method according to the invention may therefore advantageously be a passive method, i.e. one which does not comprise a motor for setting the fluid in flow.

According to one embodiment, the online measurement method may comprise a preliminary step consisting in installing a viscosity measurement device, comprising the permeable material, either on a conduit conveying the fluid to be analyzed or as a parallel branch on a conduit containing the fluid to be analyzed.

Furthermore, the method to which the present invention relates may be a continuous measurement method. The viscosity of the fluid may be measured at the frequency desired by the user, in the limit of the measurement frequency of the flow rate of the fluid and the measurement frequency of the pressure difference of the fluid between the pressure upstream of the permeable material and the pressure downstream of the permeable material. The measurement frequency may be between 10⁻⁵ Hz and 10³ Hz, more preferably between 10⁻³ Hz and 10 Hz, and even more preferably between 0.1 Hz and 1 Hz. The method according to the invention therefore makes it possible to measure the viscosity of a fluid continuously, without having to stop its flow. It can therefore be suitable for supervising an industrial process or monitoring the progress of a chemical reaction, for example.

The present invention also relates to a viscosimeter which can be used for carrying out the measurement method to which the present invention relates.

The viscosimeter to which the present invention relates comprises:
a cell comprising two chambers separated by a permeable material, the first chamber comprising an inlet opening for a fluid and the second chamber comprising an outlet opening for a fluid;
a means for measuring the pressure difference between the first and second chambers;
a flow meter for measuring the flow rate of the fluid.

During its use, the fluid whose viscosity is intended to be measured passes through the cell. The fluid enters the first chamber through the inlet opening provided, passes through the permeable material then into the second chamber, and leaves through the outlet opening provided in this second chamber. The passage of the fluid through the permeable material causes a pressure drop. This is why the first chamber is also referred to by the term “high-pressure chamber” and the second chamber is also referred to by the term “low-pressure chamber”.

The high-pressure chamber and the low-pressure chamber may, independently of one another, have a volume of between 50 mm³ and 8.10⁸ mm³, preferably between 400 mm³ and 6.10⁶ mm³, and more preferably between 2827 mm³ and 7.10 ⁴ mm³.

The chambers may advantageously be designed in such a way that the dynamic pressure of the flow inside them is substantially zero. In this way, the value of the pressure measured inside the chambers corresponds only to the value of the static pressure. The calculation uncertainties associated with the appearance of a regular pressure drop term are minimized. So that the dynamic pressure of the flow inside the chambers is substantially zero, it is preferable for the inlet and outlet openings, respectively located in the high-pressure chamber and the low-pressure chamber, to have a diameter less than the diameter of the chambers. Preferably, the ratio of the diameter of the opening to the diameter of the chamber may be less than 0.75, more preferably less than 0.5 and even more preferably than 0.1.

According to one embodiment, the cell comprises a means for ensuring leaktightness between the permeable material and the wall of the cell. This means may in particular be a seal. In particular, the permeable material separating the two chambers may exert a compression force on the seal, said compression force resulting at least in part from the pressure difference between the first chamber and the second chamber.

According to one embodiment, the first and second chambers of the cell have cylindrical symmetry about an axis x. The inlet and outlet openings of the cell may be aligned with this axis x. However, other embodiments in which the openings are not aligned with this axis x are envisioned. According to one embodiment, these inlet and outlet openings are not axially aligned.

The permeable material may have the shape of a round pellet. It may be oriented in a plane perpendicular to the axis x. The seal used as a means for ensuring leaktightness between the permeable material and the wall of the cell may furthermore have the shape of a ring and be oriented in a plane perpendicular to the axis x. Advantageously, said seal may bear on an annular shoulder inside the second chamber of the cell, and the permeable material bears on said seal. Along the axis x, the elements therefore lie in the following order: inlet opening of the cell, first chamber, permeable material, seal, shoulder, second chamber and outlet opening of the cell.

Said shoulder may in particular have an annular lip along the axis x and oriented toward the inlet opening of the cell. Said lip advantageously makes it possible to improve the leaktightness between the permeable material and the wall of the cell, because the pressure which is exerted by the seal on this lip is greater than the pressure which is exerted on the shoulder overall.

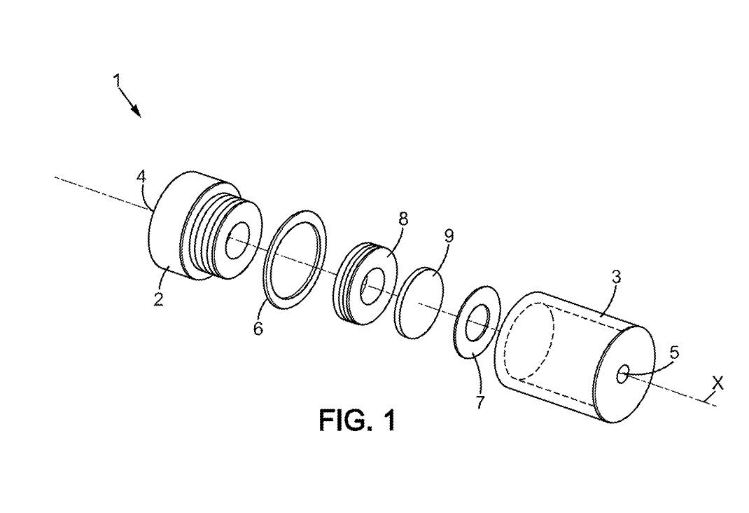

According to a particular embodiment, which is represented in FIG. 1, the cell 1 comprises two hollow cylindrical pieces 2 and 3. The inlet opening 4 for the fluid is provided in the cylindrical piece 2. The outlet opening 5 for the fluid is provided in the cylindrical piece 3. The cell 1 furthermore comprises a sealing joint 6 for the cell and a sealing joint 7 for the permeable material. Lastly, the cell comprises a nut 8. According to this embodiment, the permeable material 9 has the shape of a round pellet which is seated inside the cylindrical piece 3 between the seal 7 and the nut 8. The two hollow cylindrical pieces 2 and 3, the two seals 6 and 7, the permeable material 9 and the nut 8 all have a cylindrical symmetry with respect to an axis x. The inlet opening 4 and the outlet opening 5 of the cell 1 are aligned along this axis x.

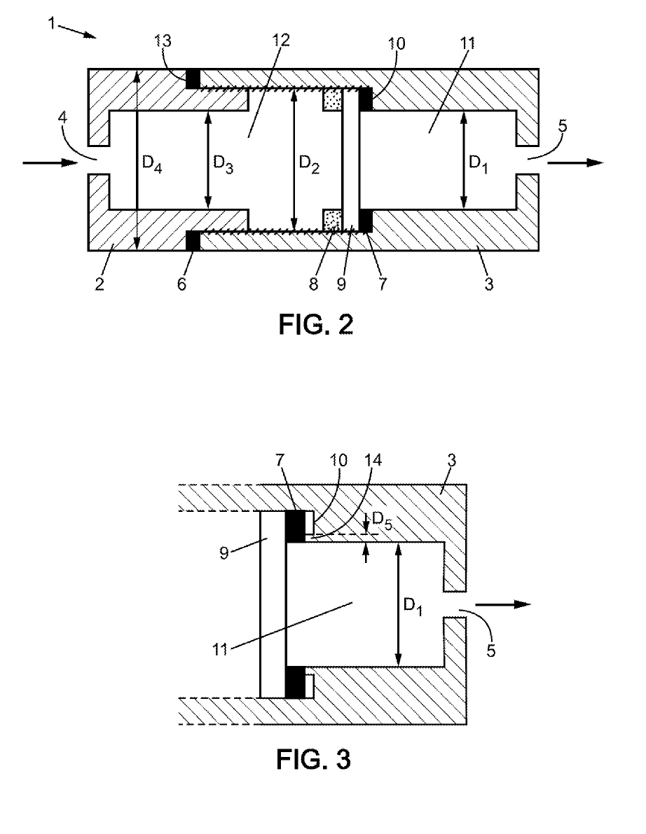

FIG. 2 represents a view in section of the cell of FIG. 1 in the assembled state. The piece 3 is formed by a cylinder having an open end and a closed end, the outlet opening 5 for the fluid being provided in said closed end. This outlet opening 5 may be one or more holes centered or not centered with respect to the cylinder. The piece 3 consists of a first cylindrical part, of internal diameter D₁, located on the side of the outlet 5, then a second cylindrical part, of internal diameter D₂, D₂ being greater than D₁. The internal wall of the piece 3 comprises an annular shoulder 10, the width of which is equal to one half of D₂ minus D₁.

The sealing joint 7 for the permeable material, according to the particular embodiment represented in FIG. 2, is inserted inside the second cylindrical part of the piece 3 and bears on the shoulder 10. In particular, the internal diameter of the seal 7 may be equal to D₁ and its external diameter is equal to D₂. The fact that the internal diameter of the joint 7 is equal to D₁ can advantageously make it possible not to modify the passage cross section of the fluid through the permeable material.

The permeable material 9 is in turn inserted inside the second cylindrical part of the piece 3 and bears on the seal 7. In particular, the diameter of the permeable material, which is a round pellet, may be equal to D₂.

According to this embodiment, the internal surface of the second cylindrical part of the piece is threaded. The nut 8 is screwed inside the second cylindrical part of the piece 3 and becomes placed against the permeable material 9 so as to block it. In particular, the internal diameter of the nut may be equal to D₁. The fact that the internal diameter of the nut 8 is equal to D₁ can advantageously make it possible not to modify the passage cross section of the fluid through the permeable material.

Advantageously, the nut 8 may be equipped with recesses for screwing the nut with the aid of a tool. In particular, such recesses may not be through recesses, that is to say the recesses arranged on one of the faces of the nut do not open onto the other face of the nut. The presence of non-through recesses can advantageously make it possible not to modify the passage cross section of the fluid through the permeable material.

The nut 8 cooperating with the screw thread of the piece 3 and the shoulder 10 make it possible to fix the permeable material inside the cell.

The piece 2 is formed by a cylinder having an open end and a closed end, the inlet opening 4 for the fluid being provided in said closed end. This inlet opening 4 may be one or more holes centered or not centered with respect to the cylinder. The interior of the cylindrical piece 2 has a diameter D₃ which may be equal to the diameter D₁. The fact that D₃ is equal to D₁ can advantageously make it possible not to modify the passage cross section of the fluid in the cell 1. The piece 2 comprises a first cylindrical part, of external diameter D₄, located on the side of the inlet opening 4, then a second cylindrical part, of internal diameter D₂, D₂ being less than D₄. The exterior of the piece 2 therefore comprises an annular shoulder 13, the width of which is equal to one half of D₄ minus D₂.

The sealing joint 6 for the cell, according to the particular embodiment represented in FIG. 2, is installed around the narrow second cylindrical part of the piece 2 and bears on the shoulder 13. In particular, the internal diameter of the seal 6 may be equal to D₂ and its external diameter is equal to D₄.

According to this embodiment, the external surface of the second cylindrical part of the piece 2 is threaded. The piece 2 is screwed to the piece 3, by screwing the second cylindrical part of the piece 2 inside the second cylindrical part of the piece 3. The pieces 2 and 3 may advantageously be provided with one or more flats on their external surface, so as to offer purchase for tightening the screw connection.

The first cylindrical part of the piece 3 and the permeable material 9 define the low-pressure chamber 11 of the cell. The piece 2, the second cylindrical part of the piece 3 and the permeable material 9 define the high-pressure chamber 12 of the cell.

The seal 7 makes it possible to ensure leaktightness between the permeable material 9 and the interior wall of the cell 1, advantageously making it possible for the fluid to flow only through the permeable material 9.

The seal 6 makes it possible to ensure leaktightness between the high-pressure chamber 12 and the exterior of the cell 1.

According to a particular embodiment, which is represented in FIG. 3, the shoulder 10 has a lip 14 in the direction of the seal 7, forming a ring of internal diameter D₁ and width D₅. The width D₅ is less than the width of the shoulder 14, preferably less than half the shoulder 14, more preferably less than one fourth of the shoulder 14.

The presence of the lip 14 makes it possible to ensure better leaktightness between the permeable material 9 and the interior wall of the cell 1, because the lip 14 exerts a greater pressure on the seal 7.

Whatever the embodiment of the cell of the viscosimeter according to the present invention, its various mechanical elements will be judiciously selected by the person skilled in the art in order to withstand the conditions of temperature and pressure with which he wishes to use this device. For example, the seals used for ensuring the leaktightness may be made of carbon so as to withstand the high temperatures and high pressures. They may also be made of polytetrafluoroethylene. Likewise, the cell itself may for example be made of bronze, steel or stainless steel, typically 316L steel according to the AISI standard.

The means for measuring the pressure difference of the fluid between the pressure upstream of the permeable material and the pressure downstream of the permeable material may be any sensor known to the person skilled in the art.

According to one embodiment, it consists of a differential pressure sensor.

According to another embodiment, it consists of a pair of pressure sensors, one arranged upstream of the permeable material and the other arranged downstream of the permeable material, and the pressure difference is measured by subtracting the measurements of the two sensors.

According to a particular embodiment, a first pressure sensor, or the first sensor of a differential pressure sensor, may be arranged in the first chamber of the cell in order to measure the pressure of the fluid upstream of the permeable material, and a second pressure sensor, or the second sensor of a differential pressure sensor, may be arranged in the second chamber of the cell in order to measure the pressure of the fluid downstream of the permeable material.

One or more openings may be formed in the cell of the viscosimeter in order to permit introduction of these sensors.

In one embodiment of the viscosimeter according to the present invention, in which the first and second chambers of the cell have cylindrical symmetry about an axis, the opening or openings may be formed either radially or in a direction parallel to said axis.

The means for measuring the flow rate of the fluid may be any flow meter known to the person skilled in the art.

The choice of the flow meter has been described above. It may in particular be a mass flow meter, in particular a Coriolis-effect mass flow meter.

According to one embodiment, a Coriolis-effect mass flow meter is arranged upstream or downstream of the cell, in a region in which the fluid is at a temperature and a pressure that is in accordance with the specifications of the Coriolis-effect flow meter. Furthermore, the Coriolis-effect mass flow meter may advantageously be placed in a stable support.

The viscosimeter to which the present invention relates may furthermore comprise one or more means for measuring the temperature. In particular, a temperature sensor may be located inside the cell of the viscosimeter in order to measure the temperature of the fluid. According to a particular embodiment, a first temperature sensor may be arranged in the first chamber of the cell in order to measure the temperature of the fluid upstream of the permeable material, and a second temperature sensor may be arranged in the second chamber of the cell in order to measure the temperature of the fluid downstream of the permeable material.

One or more openings may be formed in the cell of the viscosimeter in order to permit introduction of the sensor or sensors.

In one embodiment of the viscosimeter according to the present invention, in which the first and second chambers of the cell have cylindrical symmetry about an axis, the opening or openings may be formed either radially or in a direction parallel to said axis.

The viscosimeter to which the present invention relates may furthermore comprise a means for collecting the measurements of flow rate and pressure difference and a means for calculating and displaying the viscosity of the fluid. This may be an electronic system, for example a computer. This system makes it possible to provide the operator with the value of the viscosity measured in the device to which the invention relates. Advantageously, the electronic systems which may be present in the device may be remote from the cell of the viscosimeter. They may, for example, be shielded from water, humidity, sources of heat or vibration. This makes it possible to obtain a solid and robust device.

The viscosimeter to which the present invention relates may be placed as a parallel branch on a conduit containing the fluid to be analyzed. This conduit may advantageously form part of an industrial unit. In particular, the inlet opening and the outlet opening of the cell may be connected in bypass, that is to say as a parallel branch, to a conduit conveying the fluid whose viscosity is intended to be measured. In this case, only a fraction of said fluid passes through the cell. According to an alternative embodiment, the inlet opening and the outlet opening of the cell may be placed directly on a conduit conveying the fluid whose viscosity is intended to be measured. In this case, all of said fluid passes through the cell.

### EXAMPLE

A cell as represented in FIGS. 1, 2 and 3 was manufactured from 316L stainless steel.

In this cell:

D₁=D₃=16 mm

D₂=30 mm

D₄=45 mm

The passage cross section of the fluid through the porous material is 2.01.10⁻⁴ m².

On the side of the inlet opening 4, two openings were formed and a pressure sensor and a temperature sensor were arranged in the first chamber 12 via these two openings. Likewise, two other openings were formed on the side of the outlet opening 5, and a pressure sensor and a temperature sensor were also arranged in the second chamber 11 via these two openings.

The two pressure sensors are the two probes of a differential pressure sensor.

A Coriolis-effect mass flow meter and a hot-wire thermal volume flow meter were arranged on the inlet conduit of the cell.

### Test No. 1: Measurement of the Kinematic Viscosity of Dinitrogen

The permeable material used in test 1 was a round pellet with thickness 2 mm of 316L steel according to the AISI standard (Federal Mogul, Poral Class 3), having the following characteristics:

Porosity=9%

K_{D}=2.10⁻¹³ m²

K_{F}=5.10⁻⁷ m

A flow of dinitrogen was circulated with the aid of a pressurized bottle. The flow of the fluid was laminar, and the regime was steady-state.

The following measurements were taken:

Tᵢₙₗₑₜ=Tₒᵤₜₗₑₜ=294 K

Pᵢₙₗₑₜ=5 bar

ΔP=8.10⁴ Pa

Dₘ=0.25 g/s

Applying Darcy's law made it possible to calculate that the fluid had a kinematic viscosity of 1.5.10⁻⁵ m²/s.

### Test No. 2: Measurement of the Kinematic Viscosity of Dodecane

The permeable material used in test 2 was a round pellet with thickness 3 mm of bronze (Federal Mogul, Poral Class 30) having the following characteristics:

Porosity=9%

K_{D}=2.10⁻¹³ m²

K_{F}=5.10⁻⁷ m

A flow of dodecane was circulated with the aid of a pump. The flow of the fluid was laminar, and the regime was steady-state.

The following measurements were taken:

Tᵢₙₗₑₜ=Tₒᵤₜₗₑₜ=298 K

Pᵢₙₗₑₜ=15 bar

ΔP=1.2.10⁴ Pa

Dₘ=50 mg/s

Applying Darcy's law made it possible to calculate that the fluid had a kinematic viscosity of 1.8.10⁻⁶ m²/s.

### Test No. 3: Measurement of the Kinematic Viscosity of Dodecane

The permeable material used in test 3 was the same as that of test 2.

A flow of dodecane was circulated with the aid of a pump. The flow of the fluid was laminar, and the regime was steady-state.

The following measurements were taken:

Tᵢₙₗₑₜ=Tₒᵤₜₗₑₜ=500 K

Pᵢₙₗₑₜ=30 bar

ΔP=2.10³ Pa

Dₘ=33 mg/s

Applying Darcy's law made it possible to calculate that the fluid had a kinematic viscosity of 5.10⁻⁷ m²/s.

### Test No. 4: Measurement of the Dynamic Viscosity and the Kinematic Viscosity of Dinitrogen

The permeable material used in test 5 was a round pellet with thickness 3 mm of bronze (Federal Mogul, Poral Class 30) having the following characteristics:

Porosity=34%

K_{D}=8.8.10⁻¹² m²

K_{F}=3.10⁻⁶ m

A flow of dinitrogen was circulated with the aid of a pressurized bottle. The flow of the fluid was laminar, and the regime was steady-state.

The following measurements were taken:

Tᵢₙₗₑₜ=Tₒᵤₜₗₑₜ=300 K

Pᵢₙₗₑₜ=55 bar

ΔP=2.10⁵ Pa

Dₘ=6 g/s

Dᵥ=4.10^{-4 m}³/s

Applying Brinkman's law made it possible to calculate that the fluid had a dynamic viscosity of 1.2.10⁻⁵ Pa·s and a kinematic viscosity of 8.10⁻⁷ m²/s.

1-17. (canceled)

18. A method for measuring the viscosity of a fluid, comprising the steps consisting in:
passing the fluid through a permeable material;
measuring the flow rate of the fluid by means of a flow meter;
measuring the pressure difference of the fluid between the pressure upstream of the permeable material and the pressure downstream of the permeable material;
applying a flow law of the fluids through a permeable material in order to determine the viscosity of the fluid.

19. The method as claimed in claim 18, wherein the flow law of the fluids through a permeable medium is selected from Darcy's law and Brinkman's law.

20. The method as claimed in claim 18, wherein the pressure of the fluid upstream of the permeable material is between 10⁻⁷ bar and 1000 bar.

21. The method as claimed in claim 18, wherein the temperature of the fluid is between −40° C. and 1000° C.

22. The method as claimed in claim 18, characterized in that the viscosity measured is the kinematic viscosity of the fluid, the flow meter used being a mass flow meter.

23. The method as claimed in claim 18, which is a method for measuring the kinematic viscosity of a fluid comprising the steps consisting in:
passing the fluid in a laminar fashion through a permeable material having a Darcy permeability K_{D}, a thickness L and a cross section S which are known;
measuring the mass flow rate Dₘ of the fluid by means of a mass flow meter;
measuring the pressure difference AP of the fluid between the pressure upstream of the permeable material and the pressure downstream of the permeable material;
applying Darcy's law:
$$v = \frac{{K}_{D} \cdot S}{L} \times \frac{Δ P}{{D}_{m}}$$
in order to determine the kinematic viscosity ν of the fluid.

24. The method as claimed in claim 18, which is a method for measuring the kinematic viscosity of a fluid comprising the steps consisting in:
passing the fluid of average density ρₐᵥ in a turbulent fashion through a permeable material having a Darcy permeability K_{D}, a Forchheimer permeability K_{F}, a thickness L and a cross section S which are known;
measuring the mass flow rate Dₘ of the fluid by means of a mass flow meter;
measuring the pressure difference ΔP of the fluid between the pressure upstream of the permeable material and the pressure downstream of the permeable material;
applying Brinkman's law in the form:
$$v = \frac{{K}_{D} \cdot S}{L} \times \frac{Δ P}{{D}_{m}} - \frac{{K}_{D}}{{K}_{F} \cdot S} \times \frac{{D}_{m}}{{ρ}_{av}} .$$
in order to determine the kinematic viscosity ν of the fluid.

25. The method as claimed in claim 18, which is a method for measuring the kinematic viscosity of a fluid comprising the steps consisting in:
passing the fluid in a turbulent fashion through a permeable material having a Darcy permeability K_{D}, a Forchheimer permeability K_{F}, a thickness L and a cross section S which are known;
measuring the mass flow rate Dₘ of the fluid by means of a mass flow meter and the volume flow rate Dᵥ of the fluid by means of a volume flow meter;
measuring the pressure difference ΔP of the fluid between the pressure upstream of the permeable material and the pressure downstream of the permeable material;
applying Brinkman's law in the form:
$$v = \frac{{K}_{D} \cdot S}{L} \times \frac{Δ P}{{D}_{m}} - \frac{{K}_{D}}{{K}_{F} \cdot S} \times {D}_{V} .$$
in order to determine the kinematic viscosity ν of the fluid.

26. The method as claimed in claim 18, wherein it is an online measurement method.

27. The method as claimed in claim 18, wherein it is a continuous measurement method.

28. A viscosimeter comprising:
a cell comprising two chambers (11) and (12) separated by a permeable material (9), the first chamber (12) comprising an inlet opening (4) and the second chamber (11) comprising an outlet opening (5) for a fluid;
a means for measuring the pressure difference between the first and second chambers;
a flow meter for measuring the flow rate of the fluid.

29. The viscosimeter as claimed in claim 28, wherein the means for measuring the flow rate of the fluid is a mass flow meter.

30. The viscosimeter as claimed in claim 29, wherein the mass flow meter is a Coriolis-effect mass flow meter.

31. The viscosimeter as claimed in claim 28, wherein the cell comprises a means for ensuring leaktightness between the permeable material (9) and the wall of the cell (1), said means being a seal (7), the permeable material (9) separating the two chambers exerting a compression force on the seal (7), said compression force resulting at least in part from the pressure difference between the first chamber (12) and the second chamber (11).

32. The viscosimeter as claimed in claim 31, wherein:
the first and second chambers (11) and (12) of the cell have cylindrical symmetry about an axis (x);
the permeable material (9) has the shape of a round pellet oriented in a plane perpendicular to said axis (x), and the seal (7) has the shape of a ring oriented in a plane perpendicular to said axis (x); and
said seal (7) bears on an annular shoulder (10) inside the second chamber (11) of the cell, and the permeable material (7) bears on said seal (7).

33. The viscosimeter as claimed in claim 32, wherein said shoulder (10) has an annular lip (14) along the axis (x) and oriented toward the inlet opening (4) of the cell.

34. The viscosimeter as claimed in claim 28, wherein the inlet opening and the outlet opening of the cell are connected as a parallel branch to a conduit conveying said fluid.

35. The method as claimed in claim 20, wherein the pressure of the fluid upstream of the permeable material is between 1 bar and 800 bar.

36. The method as claimed in claim 35, wherein the pressure of the fluid upstream of the permeable material is between 20 and 250 bar.

37. The method as claimed in claim 21, wherein the temperature of the fluid is between 10° C. and 900° C.

38. The method as claimed in claim 37, wherein the temperature of the fluid is between 50° C. and 800° C.
